(19) United States
(12) Patent Application Publication
(10) Pub. No.: US 2009/0283677 A1
(43) Pub. Date: Nov. 19, 2009

(54) Section image acquiring method using combined charge particle beam apparatus and combined charge particle beam apparatus

(76) Inventor: Yutaka IKKU, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/454,253

(22) Filed: May 14, 2009

(30) Foreign Application Priority Data
May 15, 2008 (JP) 2008-128335

(51) Int. Cl. G01N 23/00

(52) U.S. Cl. 250/307; 250/306

(57) ABSTRACT

There is constructed a constitution of including a mark image taking step of taking a reference mark image by subjecting a region other than an observation object section to EB scanning, a drift amount calculating step of calculating a current SEM drift amount with regard to a predetermined time point by comparing the taken reference mark image with a reference mark reference image, and an offset amount calculating step of calculating an offset amount of a current observation object section with regard to the predetermined time point prior to a section image taking step and taking a section image by correcting an EB scanning region at the predetermined time point based on the SEM drift amount and the offset amount at the section image taking step.

### BACKGROUND OF THE INVENTION

The present invention relates to a section image acquiring method using a combined charged particle beam apparatus and a combined charged particle beam apparatus.

There is known a method of acquiring a plurality of sheets of section images of a sample by scanning an Electron Beam (EB) by a Scanning Electron Microscope (SEM) while repeating etching working utilizing a Focused Ion Beam (FIB), thereafter, overlapping the plurality of section images and constructing a three-dimensional image as one of methods of analyzing an inner structure of a sample of a semiconductor device or the like and carrying out a three-dimensional observation thereof.

The method is a method referred to as Cut & See utilizing a combined charged particle beam apparatus, which achieves an advantage of capable of observing the section image of the sample, in addition thereto, capable of carrying out the three-dimensional observation of the sample from various directions, which is not achieved by other method. Specifically, the etching working is carried out by irradiating FIB to the sample, and the section is exposed. Successively, the section image is acquired by observing the exposed section by SEM. Successively, by carrying out the etching working again, a successive section is exposed, thereafter, a second sheet of the section image is acquired by SEM observation. In this way, the plurality of sheets of section images are acquired by repeating the etching working and the SEM observation. Further, this is a method of constructing the three-dimensional image by finally overlapping the plurality of sheets of acquired section images.

In order to construct an accurate three-dimensional image, it is necessary to expose the section of the sample at an accurate position. However, in an actual combined charged particle beam apparatus, there is brought about a phenomenon of shifting positions of the focused ion beam and the sample relative to each other (FIB drift). As causes of the FIB drift, there are pointed out a temperature drift by a temperature change of a stage or the like mounting the sample, mechanical rocking of an apparatus constitution unit, and an irradiation accuracy of FIB in carrying out the etching working and the like. Further, Patent Reference 1 proposes an apparatus of promoting the irradiation accuracy of FIB, which is regarded as one of the causes of the FIB drift.

Hence, according to a background art, the etching working is carried out by irradiating FIB after correcting the FIB drift.

[Patent Reference 1] JP-A-2003-331775

However, according to the combined charged particle beam apparatus, an SEM drift is brought about in addition to the FIB drift. The SEM drift is a phenomenon of shifting positions of the electron beam and the sample relative to each other and as causes thereof, a temperature drift by a temperature change of a stage or the like mounting the sample, mechanical rocking of an apparatus constitution unit, an irradiation accuracy of the electron beam (EB) in carrying out the SEM observation and the like are pointed out. Further, there is not a correlative relationship between the FIB drift and the SEM drift, and therefore, even when the FIB drift is corrected, the SEM drift is not corrected.

According to the background art, a plurality of section images are taken without correcting the SEM drift. As a result, there poses a problem that positions of observation object sections in the plurality of section images are gradually shifted. According to the background art, when the three-dimensional image is constructed by overlapping the plurality of section images, positioning of the section image is carried out by a manual operation. Therefore, there poses a problem that enormous labor is required for constructing the three-dimensional image. Further, when the SEM drift is large, the observation object section is deviated from inside of the SEM image to pose a problem that the three-dimensional image cannot be constructed.

In recent times, a fine portion of a sample is observed, and therefore, an image taking magnification of the section image tends to be increased. Therefore, a possibility of deviating the observation object section from inside of the SEM image is increased by the SEM drift.

Further, according to the combined charged particle beam apparatus, FIB is irradiated from an upper side of the sample, and therefore, a SEM lens-barrel is arranged to constitute an acute angle relative to an optical axis of an FIB lens-barrel, and the SEM observation is carried out from a skewed upper side. In this case, at every time of taking a section image by exposing a new section, a position of the observation object section in the section image is offset to the upper side. Therefore, there poses a problem that enormous labor is required for positioning the plurality of section images. Further, there poses a problem that when an amount of slicing the section is increased, also the offset amount is increased, and the observation object section is deviated from inside of the SEM image.

The invention has been carried out in view of the above-described problems and it is an object thereof to provide a section image acquiring method using a combined charged particle beam apparatus and a combined charged particle beam apparatus capable of acquiring a plurality of section images sections of which are arranged at a predetermined position.

### SUMMARY OF THE INVENTION

In order to resolve the above-described, a section image acquiring method using a combined charged particle beam apparatus of the invention is characterized in that the image taking method acquires a plurality of section images by repeatedly carrying out a section exposing step of exposing a section of a sample by scanning a focused ion beam from a focused ion beam lens-barrel to the sample from a direction orthogonal to a surface of the sample, and a section image taking step of taking the section image of the sample by scanning a charged particle beam from a charged particle beam lens-barrel an optical axis of which is arranged to constitute an acute angle relative to an optical axis of the focused ion beam lens-barrel to the section, wherein the image taking method includes a reference mark image taking step of taking an image of a reference mark by scanning the charged particle beam to the reference mark disposed at the surface of the sample at a vicinity of a portion of exposing the section at a predetermined time point of the section exposing step, and a drift amount calculating step of calculating a drift amount of a current one of the charged particle beam based on amount of shifting a position of the reference mark image taken at the section exposing step which is carried out after the predetermined time point from a reference position by constituting the reference position by the position of the reference mark image taken at the predetermined time point, and wherein at the section image taking step with regard to the section exposed at the section exposing step which is carried out after the predetermined time point, by designating a distance from the section at the predetermined time point to the section exposed at the section exposing step which is carried out after the predetermined time point by a notation t, and designating an angle of incidence of the charged particle beam relative to a direction of a normal line of the section by a notation θ, a scanning region of the charged particle beam to the section at the predetermined time point is corrected based on an amount of adding t·sin θ to the drift amount and the section image is taken.

According to the invention, the drift amount of the charged particle beam is calculated, and the section image is taken by correcting the drift amount, and therefore, even when the section image is taken by a high lens-magnification, a plurality of section images in which the sections are arranged at the predetermined position can be acquired. At this occasion, the reference mark image is taken by scanning the charged particle beam to the reference mark arranged at the region other than the section, and therefore, a deterioration in an image quality of the section image by adherence (contamination) of an impurity to the section can be prevented.

Further, based on the distance t from the section at the predetermined time point to the current section, and the angle of incidence θ of the charged particle beam to the section, when the charged particle beam is fluctuated to scan at the same position, the offset amount on a screen of the current section image with regard to the predetermined time point can accurately be calculated as t·sin θ. The section image is taken by correcting the offset amount, and therefore, even when an amount of slicing the section is increased, the offset of the section position of the section image can be prevented. Therefore, a plurality of section images in which the sections are arranged at the predetermined position can be acquired. Further, the section image is taken by correcting the offset amount along with the drift amount, and therefore, an increase in a margin region added to a region to which attention is paid in taking the image can be restrained.

Further, at the reference mark image taking image, the reference mark image may be taken by making a lens-magnification lower than that of the section image taking step.

In this case, even when the reference mark is not present at the vicinity of the section, the drift amount can be calculated by taking the mark image.

Further, at the section image taking step, a region to be taken may be limited to the section image region to be enlarged to be taken by constituting an image taking condition by a lens-magnification the same as that of the reference mark image taking step.

In this case, time is not required for changing the lens-magnification, and therefore, an increase in an image taking time period can be restrained.

Further, it is preferable that the reference mark is used also for calculating the drift amount of the focused ion beam.

In this case, it is not necessary to separately form the reference mark, and therefore, a necessary preparing operation can be reduced by simplifying the sample working step.

On the other hand, the combined charged particle beam apparatus of the invention is characterized by including a focused ion beam lens-barrel of exposing a section of a sample by scanning a focused ion beam to the sample from a direction orthogonal to a surface of the sample, a charged particle beam lens-barrel an optical axis of which is arranged to constitute an acute angle by an optical axis of the focused ion beam lens barrel for scanning a charged particle beam to the section, and section image taking means of taking a section image of the sample by using the charged particle beam lens-barrel, wherein the section image taking means is formed to be able to take an image of a reference mark by scanning the charged particle beam to the reference mark disposed at a surface of the sample at a vicinity of a portion of exposing the section, further including drift amount calculating means for calculating a drift amount of a current one of the charged particle beam based on an amount of shifting a position of a reference mark image taken in exposing a section which is carried out after a predetermined time point from a reference position by constituting the reference position by the position of the reference mark image taken at the predetermined time point in exposing the section, wherein the section image taking means is formed to be able to take the section image by designating a distance from the section at the predetermined time point to a section exposed after the predetermined time point by a notation t, designating an angle of incidence of the charged particle beam relative to a direction of a normal line of the section by a notation θ, and correcting a scanning region of the charged particle beam with regard to the section at the predetermined time point based on an amount of adding t·sin θ to the drift amount.

According to the invention, a deterioration in an image quality of the section image by adherence (contamination) of an impurity to the section can be prevented. Further, the offset amount of the current section at the predetermined time point can accurately be calculated. Further, even when an amount of slicing a section is increased, the offset of the section position of the section image can be prevented. Therefore, even when the section image is taken by a high lens-magnification, the plurality of section images in which the sections are arranged at the predetermined position can be acquired.

Further, the section image taking means may be formed to be able to take the reference mark image by making the lens-magnification lower than that in taking the section image.

In this case, even when the reference mark is not present at the vicinity of the section, the drift amount can be calculated by taking the mark image.

The section image taking means may be formed to limit a region to be taken to the section image region to be enlarged to be taken by constituting an image taking condition by a lens-magnification the same as that in taking the reference mark image.

In this case, time is not required in changing the lens-magnification, and therefore, an increase in an image taking time period can be restrained.

According to the section image acquiring method using the combined charged particle beam apparatus and the combined charged particle beam apparatus of the invention, the drift amount of the charged particle beam is calculated, the section image is taken by correcting the drift amount, and therefore, even when the section image is taken by the high lens-magnification, the plurality of section images in which the sections are arranged at the predetermined position can be acquired. At that occasion, the mark image is taken by scanning the charged particle beam to the region other than the section, and therefore, a deterioration in an image quality of the section image by adherence (contamination) of an impurity to the section can be prevented.

Further, based on the distance t from the section at the predetermined time point to the current section and the angle of incidence θ of the charged particle beam to the section, when the charged particle beam is fluctuated to scan at the same position, the offset amount on a screen of the current section image with regard to the predetermined time point can accurately be calculated as t·sin θ. The section image is taken by correcting the offset amount, and therefore, even when the amount of slicing the section is increased, the offset of the section position of the section image can be prevented. Therefore, even when the section image is taken by a high lens-magnification, the plurality of section images in which the sections are arranged at the predetermined position can be acquired.

### BRIEF DESCRIPTION OF THE DRAWINGS

FIG. 1 is an outline constitution view of an image acquiring apparatus according to an embodiment.

FIG. 2 is a flowchart of an image acquiring method according to the embodiment.

FIG. 3 is a perspective view of a worked sample.

FIG. 4 is an SEM observation field of view at a predetermined time point.

FIG. 5 is a current SEM observation field of view.

FIG. 6 is an explanatory view of a drift amount calculating step.

FIG. 7 is an explanatory view of an offset of an observation object section, and is a sectional view taken along a line A-A of FIG. 3.

FIG. 8 is a section image in a state of offsetting the observation object section.

FIG. 9 is an explanatory view of a first correcting method.

### DESCRIPTION OF THE PREFERRED EMBODIMENT

In the following, an embodiment of the invention will be explained in reference to the attached drawings. In the following respective drawings, an orthogonal coordinates system is set for convenience of explanation.

### (Combined Charged Particle Beam Apparatus)

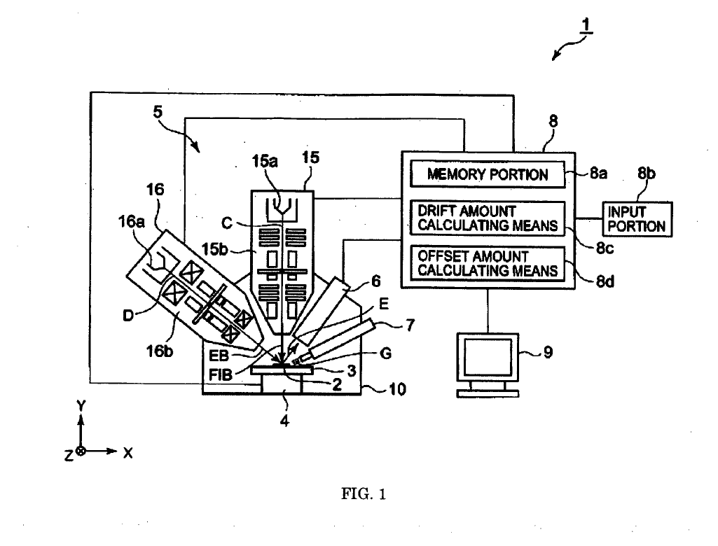

FIG. 1 is an outline constitution view of a combined charged particle beam apparatus according to an embodiment. The combined charged particle beam apparatus according to the embodiment are charged particle beam apparatus of FIB-SEM combined type capable of respectively irradiating two kinds of charged particle beams of a focused ion beam (FIB) and an electron beam (EB). The combined charged particle beam apparatus include a sample base 3 mounted with a sample 2, a stage 4 of displacing the sample base 3, an irradiation mechanism 5 of irradiating FIB and EB to the sample 2, a secondary charged particle beam detector 6 of detecting a secondary charged particle E generated by irradiation of FIB and EB, a gas gun 7 of supplying a raw material gas G for forming a deposition film DP at a vicinity of the sample 2 irradiated with FIB, a control portion 8 of generating image data of the sample 2 based on the detected secondary charged particle E, and a display portion 9 of displaying generated image data.

The sample base 3 mounted with the sample 2 is contained at inside of a vacuum sample chamber 10, and irradiation of FIB and EB and supply of the raw material gas G and the like are carried out to the sample 2 at inside of the vacuum sample chamber 10. The stage 4 is operated in accordance with an instruction of the control portion 8, for example, the sample base 3 can be displaced by 5 axes. That is, the sample base 3 is made to be able to be moved respectively along X axis and Y axis in parallel with a horizontal face and orthogonal to each other, and Z axis orthogonal to X axis and Y axis, and the sample 3 is made to be able to be rotated around Z axis, and the sample base 3 is made to be able to be tilted around X axis (Y axis). FIB and EB are made to be able to be irradiated in a state of displacing the sample 2 in all of attitudes by displacing the sample base 3 in 5 axes in this way.

The irradiation mechanism 5 is constituted by an FIB lens-barrel 15 of irradiating FIB to the sample 2, and an SEM lens-barrel 16 of irradiating EB. The FIB lens-barrel 15 includes an ion generating source 15a and an ion optical system 15b, and an ion C generated at the ion generating source 15a is slenderly narrowed by the ion optical system 15b, thereafter, irradiated to the sample 2. Further, the SEM lens-barrel 16 includes an electron generating source 16a and an electron optical system 16b, an electron D generated at the electron generating source 16a is slenderly narrowed by the electron optical system 16b to constitute an electron beam EB, thereafter, irradiated to the sample 2. The electron optical system 16b is constituted by including a condenser lens of focusing the electron beam, a diaphragm of narrowing the electron beam, an aligner of adjusting an optical axis of the electron beam, an object lens of focusing the electron beam to the sample, and a deflector of scanning the electron beam above the sample successively from a side of the electron generating source 16a to a side of the sample 2.

Further, although physical arrangements of the FIB lens-barrel 15 and the EB lens-barrel 16 may be interchanged with no problem, the following operation will be explained in accordance with an arrangement example of FIG. 1. A center axis (optical axis) of the FIB lens-barrel 15 is arranged in parallel with Z axis. In order to avoid an interference with the FIB lens-barrel 15, a center axis (optical axis) of the SEM lens-barrel 16 is arranged to be intersected with Z axis. Further, in order to ensure accuracies of irradiating FIB and EB to the sample 2, front ends of the FIB lens-barrel 15 and the SEM lens-barrel 16 need to be arranged to be proximate to the sample 2. Therefore, an angle of intersecting the center axis of the SEM lens-barrel 16 and Z axis becomes wide (for example, an acute angle of about 60°). Thereby, EB is irradiated from the skewed upper side of the sample 2.

A control portion 8 is connected with an input portion 8b capable of being inputted by an operator, and based on a signal inputted by the input portion 8b, the above-described respective constituent portions are made to be able to be controlled generally. That is, the control portion 8 is made to be able to displace the sample base 3 and the sample 2 by operating the stage 4, adjust beam diameters, irradiation positions, irradiation timings of FIB and EB and control a timing of supplying the raw material gas G and the like.

Further, the control portion 8 generates sample images (section image and mark image) by converting the secondary charged particle E detected by the secondary charged particle detector 6 into a brightness signal. Further, the generated sample image is stored to a memory portion 8a to be acquired and displayed on the display portion 9. Thereby, the operator is made to be able to confirm the generated sample image.

The control portion 8 is provided with drift amount calculating means 8c and offset amount calculating means 8d. The drift amount calculating means 8c calculates drift amounts of FIB and EB. The drift signifies that positions of irradiating FIB and EB to the sample 2 are shifted. As causes of the drift, a temperature drift by a temperature change of the stage 4 or the like mounted with the sample 2, mechanical rocking of the apparatus constitution unit, irradiation accuracies of FIB and EB and the like are pointed out. Specific operations of the drift amount calculating means 8c and the offset amount calculating means 8d will be described later.

### (Section Image Acquiring Method Using Combined Charged Particle Beam Apparatus)

Next, an explanation will be given of a section image acquiring method using the combined charged particle beam apparatus according to the embodiment.

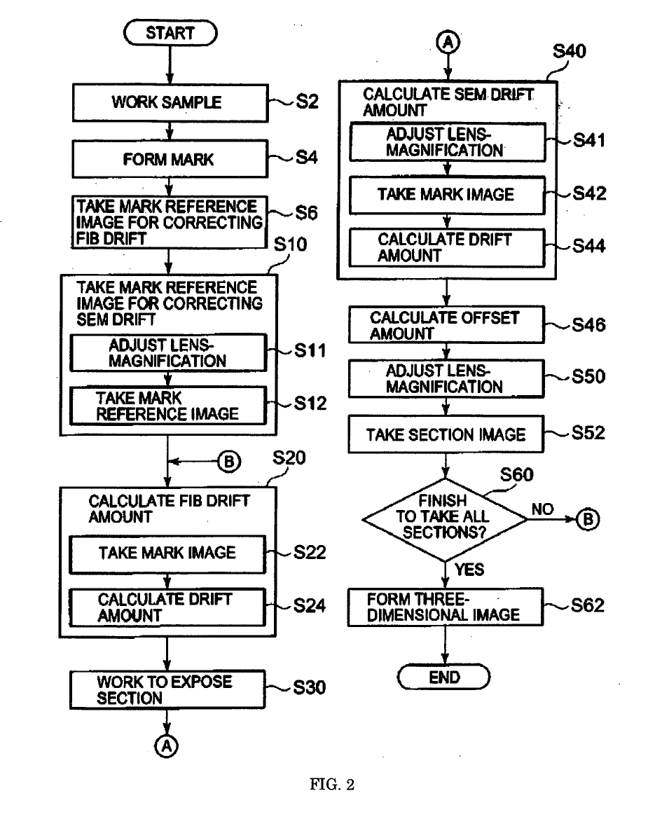

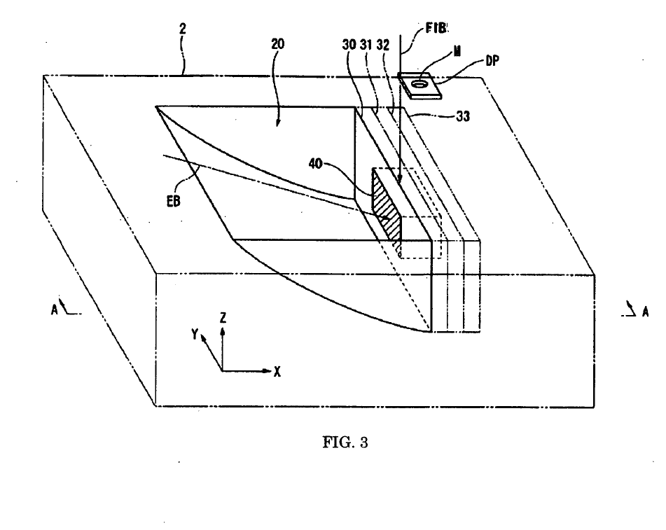

FIG. 2 is a flowchart of the section image acquiring method according to the embodiment, FIG. 3 is a perspective view of a worked sample. According to the embodiment, in order to analyze an inner structure of an observation object section 40 of the sample 2, images (section images) including the observation object section 40 are taken in a plurality of sections 30 through 33, the section images are three-dimensionally overlapped, thereby, a three-dimensional image of the observation object section 40 is constructed. Specifically, a section exposure working step (S30) of exposing a section 31 including the observation object section 40 by irradiating FIB, a section image taking step (S52) of taking a section image by scanning EB to the section 31 are repeatedly carried out with regard to sections 31 through 33.

The section image acquiring method according to the embodiment will successively be explained. First, the sample 2 is worked in order to enable to irradiate EB to the section 30 (sample working step: S2). Specifically, a groove 20 is formed by irradiating FIB from the upper side of the sample 2 shown in FIG. 3. The groove 20 is extended along X direction and a wall face on +X side becomes the section 30. A depth of the groove 20 is gradually reduced in −X direction from the section 30. By forming the groove 20, EB is made to be able to be irradiated to the section 30 from a skewed upper side in parallel with XZ face.

Next, a reference mark (hereinafter, simply referred to as mark) constituting a reference of calculating the drift amount is formed (mark forming step: S4). First, a deposition film DP is formed at a surface of the sample 2. Specifically, the deposition film DP is formed by irradiating FIB to the surface of the sample 2 while supplying the raw material gas G from the gas gun 7 shown in FIG. 1. Next, a mark M constituted by a circular hole or the like is formed by carrying out etching working by irradiating FIB to the deposition film DP.

Next, a mark reference image for correcting the FIB drift is taken (S6). Here, a mark reference image including the mark M is taken by scanning FIB from an upper side of the sample 2 at a certain predetermined time point.

Next, the mark reference image for correcting the SEM drift is taken (S10).

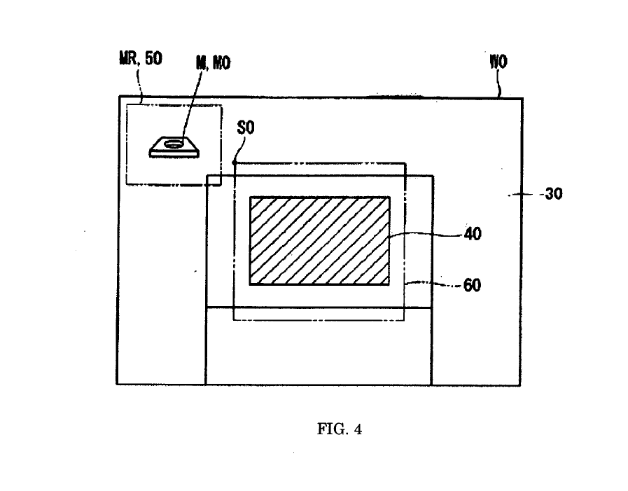

FIG. 4 shows a field of view of SEM observation at a certain predetermined time point. First, a lens-magnification of SEM is adjusted such that the mark M is brought to the SEM observation field of view W0 (lens-magnification adjusting step; S11). Whereas at a lens-magnification adjusting step (S50) of taking a section image mentioned later, the lens-magnification is set to be high in order to take an image of a fine portion of the observation object section 40, according to the lens-magnification adjusting step (S11), the lens-magnification is set to below in order to take the image of the mark M and arranged to be remote from the observation object section 40. Further, when the mark M is arranged at inside of the SEM observation field of view, a high lens-magnification the same as that in taking the section image may be adopted by omitting the lens-magnification adjusting step (S11).

Next, the mark reference image for correcting the SEM drift is taken by scanning EB to the mark M (mark reference image taking step; S12). Here, when EB is scanned to the observation object section 40, there is a concern of not only dosing extraneous EB to the observation object section 40 but deteriorating an image quality of the section image by adhering an impurity to the observation object section (contamination). Hence, the mark reference image is taken by scanning EB only to a region MR at which the mark M is made to be able to appear. In FIG. 4, the mark reference image 50 including the mark M0 is taken by scanning EB only to the region MR of the SEM observation field of view W0.

### (FIB Drift Correction, Section Exposure Working)

Next, the FIB drift amount is calculated by drift amount calculating means (FIB drift amount calculating step; S20). Specifically, a mark image including the mark M is taken by scanning FIB from the upper side of the sample 2 shown in FIG. 3 (mark image taking step; S22). Next, a gravitational center of the mark M of the mark image is calculated. Further, a mark gravitational center position of the mark image taken at a current time and a mark gravitational center position of the mark reference image taken at the predetermined time point are compared, and an amount of shifting the both is calculated as the FIB drift amount (drift amount calculating step; S24).

Next, the sample 2 is subjected to etching working by scanning FIB while correcting the FIB drift and the section 31 is exposed (section exposure working step; S30). Specifically, FIB is scanned by moving a start position of scanning (digital scan) of FIB by the calculated FIB drift amount. Thereby, the FIB drift is corrected and the section 31 can be exposed at an accurate position. At the section exposure working step, FIB is irradiated orthogonally to a surface of the sample 2 (in parallel with the section 30), a surface of the section 30 is cut off and the section 31 is exposed.

### (SEM Drift Correction, Section Image Taking)

Next, the SEM drift amount is calculated by drift amount calculating means (SEM drift amount calculating step; S40).

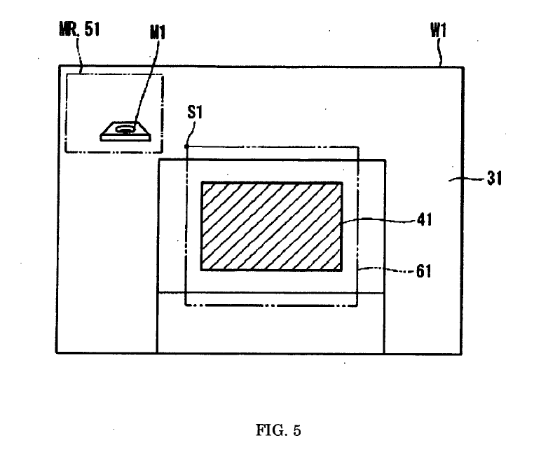

FIG. 5 is a current SEM observation field of view. First, the lens-magnification of SEM is adjusted by a lens-magnification the same as that in taking the mark reference image (magnification adjusting step; S41). Next, the mark image is taken by scanning EB to the region MR the same as that in taking the mark reference image (mark image taking step; S42). In FIG. 5, a mark image 51 including the mark Ml is taken by scanning EB only to the region MR of the SEM observation field of view W1.

Next, a SEM drift amount is calculated from the mark image (drift amount calculating step; S44).

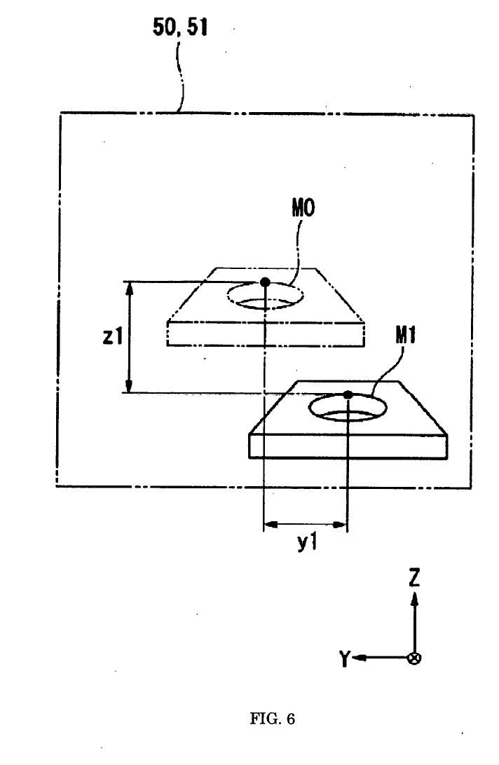

FIG. 6 is an explanatory view of the drift amount calculating step. First, an amount of moving the mark image 51 (−y1, −z1) is calculated by carrying out a pattern matching of the mark reference image 50 and the mark image 51 to constitute the SEM drift amount.

Next, an offset amount of the observation object section in scanning the observation object section is calculated by the offset amount calculating means by deflecting to move EB within the same range at inside of the SEM lens-barrel, that is, by fluctuating the beam similarly (offset amount calculating step; S46).

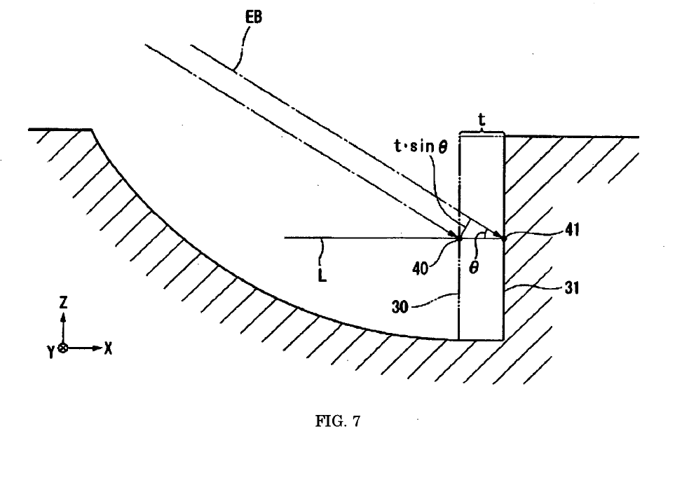

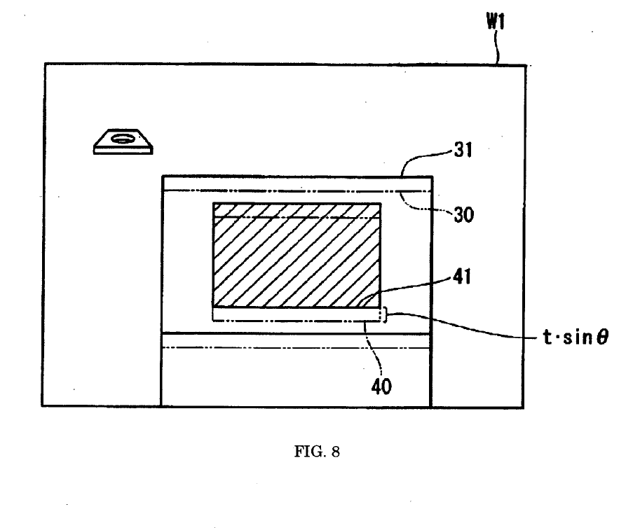

FIG. 7 is an explanatory view of the offset of the observation object section, and a sectional view taken along a line A-A of FIG. 3. Further, FIG. 8 shows a section image in a state of offsetting the observation object section. According to the embodiment, as shown by FIG. 7, the section image is taken by irradiating EB from skewed upper sides of sections 30, 31 from the SEM lens-barrel the optical axis of which is in parallel with XZ plane. Therefore, when the observation object section is scanned by deflecting to move EB in a range the same as that at inside of the SEM lens-barrel, an observation object section 41 of the section 31 disposed on a depth side in view from the SEM lens-barrel is offset to the upper side in a section image shown in FIG. 8 from the observation object section 40 of the section 30 disposed on this side.

In FIG. 7, an angle of incidence of EB relative to a normal line L of the sections 30, 31 is designated by notation θ, and a distance from the section 30 to the section 31 is designated by notation t. At this occasion, the offset amount of the observation object section of the section image can be represented by t·sin θ.

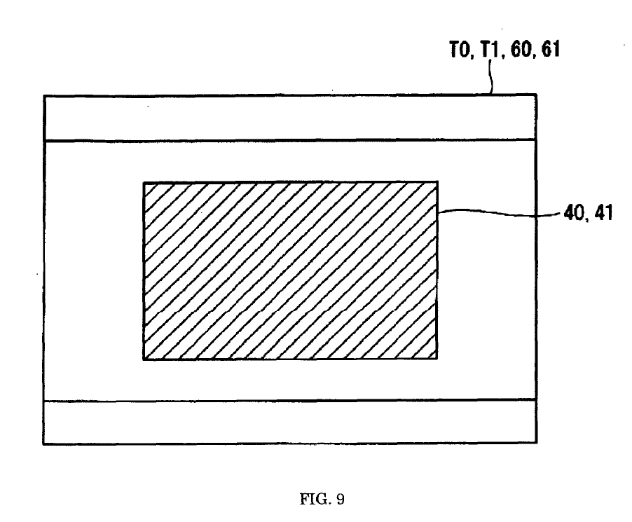

Next, the lens-magnification is adjusted in order to take the section image (lens-magnification step; S50). Here, the lens-magnification is set to be high in order to take the fine portion of the observation object section 40. Specifically, an SEM observation field of view T0 shown in FIG. 9 is provided by increasing the lens-magnification from the SEM observation field of view W0 shown in FIG. 4. At the section image taking step described below successively, a section image 60 is provided by scanning EB over an entire region of the SEM observation field of view T0 (method in correspondence with optical zoom).

Further, the section image can also be provided by scanning EB to only the portion region 60 and enlarging the taken image 60 while the SEM observation field of view W0 of the low lens-magnification shown in FIG. 4 is made to stay as it is (method in correspondence with digital zoom). In this case, time is not required for changing the lens-magnification, and therefore, an increase in an image taking time period can be restrained.

Next, the section image is taken by scanning EB while correcting the SEM drift and the offset (section image taking step; S52). As a result of the above-described, a total correction amount (dy, dz) summing up the SEM drift amount and the offset amount is represented by a following equation.

dy=−y1

dz=−Z1+t·sin θ

As a specific correcting method, a method of moving a center of the field of view by the total correction amount (in correspondence with the method in correspondence with the optical zoom) (first correcting method) and a method of moving a start position of scanning EB by the total correction amount (in correspondence with the method in correspondence with digital zoom) (second correcting method) are conceivable.

FIG. 9 is an explanatory view of the first correcting method. When a center of a field of view is moved from the SEM observation field of view W1 shown in FIG. 5 by a total correction amount (dy, dz) and the lens-magnification is enlarged, an SEM observation field of view T1 shown in FIG. 9 is constituted. A section image 61is provided by subjecting a total region of the SEM observation field of view T1 to EB scanning. As a result, a position of an observation object section 41 of the section image 61 coincides with a position of the observation object section 40 at a predetermined time point. When the EB scanning region is corrected in this way, a section image in which the observation object section is always arranged at the predetermined position can be provided.

According to the second correcting method, only a partial region 61 is subjected to EB scanning from the SEM observation field of view W1 shown in FIG. 5. A start position S1 of the EB scanning is moved by the total correction amount (dy, dz) relative to the start position S0 of EB scanning in FIG. 4. As a result, a position of the observation object section 41 in the image 61 taken in FIG. 5 coincides with a position of the observation object section 40 of the image 60 taken in FIG. 4. Further, also positions of the section images provided by enlarging two images 60, 61 coincide with each other. In this way, even when the EB scanning region is corrected, the section image in which the observation object section is always arranged at the predetermined position can be provided.

Next, it is determined whether the section images have been finished to be taken with regard to all of the sections (S60). When the determination is No, S20 through S52 are repeated for remaining sections.

When the determination of S60 is Yes, the operation proceeds to S62, a plurality of taken section images are overlapped, and a three-dimensional image of the observation object section is formed. According to the embodiment, the section image in which the observation object section is always arranged at the predetermined position is provided, and therefore, the three-dimensional image of the observation object section can be provided by simply overlapping the plurality of section images without positioning the plurality of section images.

As described above in details, according to the image acquiring method according to the invention, there is constructed a constitution of including the mark image taking step (S42) of taking the mark image by subjecting the region other than the section to EB scanning, the drift amount calculating step (S44) of calculating the current SEM drift amount with regard to the predetermined time point by comparing the taken mark image with the mark reference image, and the offset amount calculating step (S46) of calculating the offset amount of the current section with regard to the predetermined time point prior to the section image taking step (S52), and taking the section image by correcting the EB scanning region at the predetermined time point based on the SEM drift amount and the offset amount at the section image taking step (S52).

According to the constitution, the SEM drift amount is calculated, the section image is taken by correcting the drift amount, and therefore, even when the section image is taken by the high lens-magnification, the plurality of section images in which the sections are arranged at the predetermined position can be acquired. At that occasion, the mark image is taken by subjecting a region other than the section to EB scanning, and therefore, a deterioration of image quality of the section image by adherence (contamination) of an impurity to the section can be prevented.

Further, there is constructed a constitution of calculating the offset amount of the current section with regard to the predetermined time point from the predetermined time point based on the distance to the current section and the angle of incidence of the charged particle beam to the section, and therefore, the offset amount can accurately be calculated. Further, the section image is taken by correcting the offset amount, and therefore, even when an amount of slicing the sections is increased, the offset of the section position of the section image can be prevented. Therefore, the plurality of section images in which the sections are arranged at the predetermined position can be taken. Further, the section image is taken by correcting the offset amount along with the drift amount, and therefore, an increase in an image taking time period can be restrained.

Further, the technical range of the invention is not limited to the above-described embodiment but includes the above-described embodiment which is variously changed within the range not deviated from the gist of the invention. That is, a specific material or layer constitution pointed out in the embodiment is only an example, and can pertinently be changed.

For example, although the “predetermined time point” of the embodiment is constituted by time of taking an initial section image, time of taking the section image immediately therebefore may be set to the “predetermined time point”.

What is claimed is:

1. A section image acquiring method using a combined charged particle beam apparatus characterized in that the image taking method acquires a plurality of section images by repeatedly carrying out a section exposing step of exposing a section of a sample by scanning a focused ion beam from a focused ion beam lens-barrel to the sample from a direction orthogonal to a surface of the sample, and a section image taking step of taking the section image of the sample by scanning a charged particle beam from a charged particle beam lens-barrel an optical axis of which is arranged to constitute an acute angle relative to an optical axis of the focused ion beam lens-barrel to the section,
wherein the image taking method comprises:
a reference mark image taking step of taking an image of a reference mark by scanning the charged particle beam to the reference mark disposed at the surface of the sample at a vicinity of a portion of exposing the section at a predetermined time point of the section exposing step; and
a drift amount calculating step of calculating a drift amount of a current one of the charged particle beam based on an amount of shifting a position of the reference mark image taken at the section exposing step which is carried out after the predetermined time point from a reference position by constituting the reference position by the position of the reference mark image taken at the predetermined time point; and
wherein at the section image taking step with regard to the section exposed at the section exposing step which is carried out after the predetermined time point, by designating a distance from the section at the predetermined time point to the section exposed at the section exposing step which is carried out after the predetermined time point by a notation t, and designating an angle of incidence of the charged particle beam relative to a direction of a normal line of the section by a notation θ, a scanning region of the charged particle beam to the section at the predetermined time point is corrected based on an amount of adding t·sin θ to the drift amount and the section image is taken.

2. The section image acquiring method using a combined charged particle beam apparatus according to claim 1, characterized in that at the reference mark image taking step, the reference mark image is taken by making a lens-magnification lower than a lens-magnification at the section image taking step.

3. The section image acquiring method using a combined charged particle beam apparatus according to claim 1, characterized in that at the section image taking step, a taken region is limited to the section image region to be enlarged to be taken by constituting an image taking condition by a lens-magnification the same as the lens-magnification of the reference mark image taking step.

4. The section image acquiring method using a combined charged particle beam apparatus according to claim 1, characterized in that the reference mark is used also for calculating the drift amount of the focused ion beam.

5. A combined charged particle beam apparatus characterized by comprising:
a focused ion beam lens-barrel of exposing a section of a sample by scanning a focused ion beam to the sample from a direction orthogonal to a surface of the sample;
a charged particle beam lens-barrel an optical axis of which is arranged to constitute an acute angle by an optical axis of the focused ion beam lens barrel for scanning a charged particle beam to the section; and
section image taking means of taking a section image of the sample by using the charged particle beam lens-barrel;
wherein the section image taking means is formed to be able to take an image of a reference mark by scanning the charged particle beam to the reference mark disposed at a surface of the sample at a vicinity of a portion of exposing the section;
the section image taking means includes drift amount calculating means for calculating a drift amount of a current one of the charged particle beam based on an amount of shifting a position of a reference mark image taken in exposing a section which is carried out after a predetermined time point from a reference position by constituting the reference position by the position of the reference mark image taken at the predetermined time point in exposing the section; and
the section image taking means is formed to be able to take the section image by designating a distance from the section at the predetermined time point to a section exposed after the predetermined time point by a notation t, designating an angle of incidence of the charged particle beam relative to a direction of a normal line of the section by a notation θ, and correcting a scanning region of the charged particle beam with regard to the section at the predetermined time point based on an amount of adding t·sin θ to the drift amount.

6. The combined charged particle beam apparatus according to claim 5, characterized in that the section image taking means is formed to be able to take the reference mark image by making a lens-magnification lower than a lens-magnification in taking the section image.

7. The combined charged particle beam apparatus according to claim 5, characterized in that the section image taking means is formed to limit a region to be taken to the section image region to be enlarged to be taken by constituting an image taking condition by a lens-magnification the same as a lens-magnification in taking the reference mark image.
